(19) United States
(12) Patent Application Publication
(10) Pub. No.: US 2014/0203559 A1
(43) Pub. Date: Jul. 24, 2014

(54) CONNECTION FOR IMPROVED CURRENT BALANCING BETWEEN PARALLEL BRIDGE CIRCUITS

(71) Applicant: GENERAL ELECTRIC COMPANY, Schenectady, NY (US)

(72) Inventors: Robert Gregory Wagoner, Roanoke, VA (US); Robert Allen Seymour, Roanoke, VA (US); Duro Basic, Garching bei Munchen (DE)

(73) Assignee: GENERAL ELECTRIC COMPANY, Schenectady, NY (US)

(21) Appl. No.: 13/744,991

(22) Filed: Jan. 18, 2013

(51) Int. Cl. H02M 7/5387; H02P 9/02; H02P 27/06

(52) U.S. Cl. CPC H02M 7/5387; H02P 27/06; H02P 9/02
USPC 290/44; 363/132; 318/400.29; 322/70

(57) ABSTRACT

A connection for parallel bridge circuits in a power converter is provided. In particular, a power converter can be used to provide a desired power to a load, such as a generator, motor, electrical grid, or other suitable load. The power converter can include a plurality of bridge circuits coupled in parallel. A bridge output of each of the parallel bridge circuits can be coupled together at the load instead of at the power converter. In particular, the parallel bridge circuits can be coupled together at a location that is physically proximate the physical location of the load, such as at a plurality of terminals associated with the load. By doing so, stray inductance associated with conductors used to couple the bridge outputs of the parallel bridge circuits to the load can be effectively coupled between the parallel bridge circuits.

### FIELD OF THE INVENTION

The present disclosure relates generally to power converters, and more particularly to an improved connection for parallel bridge circuits in a power converter to reduce current imbalance among parallel bridge circuits in the power converter.

### BACKGROUND OF THE INVENTION

Power systems often include a power converter that is configured to convert an input power into a suitable power for application to a load, such as a generator, motor, electrical grid, or other suitable load. For instance, a power generation system, such as a wind generation system, can include a power converter for converting alternating current power generated at the generator into alternating current power at a grid frequency (e.g. 50/60 Hz) for application to a utility grid. An exemplary power generation system can generate AC power using a wind driven doubly fed induction generator (DFIG). A power converter can regulate the flow of electrical power between the DFIG and the grid.

To provide increased output power capability, a power converter can include a plurality of bridge circuits coupled in parallel with one another. Each bridge circuit can include a plurality of switching elements (e.g. insulated gate bipolar transistors (IGBTs)). The pulse-width-modulation (PWM) of the switching elements can be controlled according to a desired switching pattern to provide a desired output of the power converter. The use of switching elements, such as IGBTs, in a power converter can produce undesirable high frequency components in the output power provided by the power converter. To reduce these undesirable high frequency components, one or more inductors can be used in conjunction with the bridge circuits to filter the high frequency components.

For example, FIG. 1 depicts an exemplary power system 100 including parallel bridge circuits. The power system 100 includes a generator 110 configured to generate AC power and provide the AC power to a power converter 120. The power converter 120 is a two stage power converter and includes an inverter 122 and a line side converter 124 coupled together by a DC link 125. The inverter 122 receives multiphase (e.g. 3 phase) AC power from the generator 110 via a generator bus 150 and converts the AC power to DC power for application to the DC link 125. The line side converter 124 converts the DC power on the DC link 125 to a suitable AC output power to provide to the electrical grid via a line bus 160.

As illustrated, the inverter 122 can include a first bridge 132 and a second bridge 134. Each bridge 132 and 134 can include a bridge circuit for each phase (e.g. each of three phases) of the power converter 120. For instance, first bridge 132 includes a bridge circuit 136 for a phase of the first bridge 132. Second bridge 134 can include a bridge circuit 138 for a phase of the second bridge 134. The first bridge 132 and the second bridge 134 can be paralleled together such that the bridge circuit 136 is coupled in parallel with the bridge circuit 138. Each bridge circuit can include a pair of switching elements, such as IGBTs 142 and 144, coupled in series with one another. Each bridge circuit can provide an output to the generator bus 150, which provides AC power from the generator 120. The parallel bridges 132 and 134 combine six outputs into three phases on the generator bus 150.

As illustrated, the bridge output of each bridge circuit includes an output inductor (L1-L6). The output inductors L1-L6 can be used to filter high frequency components of the output power generated by the power converter 120. The output inductors L1-L6 can be built as three-phase components (e.g. wound on a single core with a separate magnetic path for each phase) such that L1-L3 are built on a single core and L4-L6 are built on a single core. As shown in FIG. 1, a bridge output of the first bridge 132 and the second bridge 134 are paralleled together at 135 at the power converter 120. As a result, the output inductors L1-L6 are effectively coupled between the parallel bridge circuits. For example, output inductors L1 and L6 are effectively coupled between parallel bridge circuits 136 and 138.

The generator bus 150 can include conductors to deliver alternating current power for each phase generated by the generator 110. The conductors can include stray wiring inductance 152. However, because the first bridge 132 and the second bridge 134 are paralleled together at the power converter 120 at 135, the stray wiring inductance 152 is not effectively coupled between the parallel bridge circuits of the power converter 120.

Using parallel bridge circuits can allow for smaller, lower cost inductors to be used in the power converter to accomplish filtering of the high frequency components of the output power. However, any difference in timing between switching of the parallel bridge circuits can cause a voltage across the inductors, leading to a circulating current between the parallel bridge circuits. This circulating current can result in a current imbalance between the parallel bridge circuits. The circulating current can be reduced by increasing the size of the output inductors effectively coupled between the parallel bridge circuits. However, increasing the size of the output inductors leads to increased cost of the power system.

Thus, a need exists for a system for reducing current imbalance among parallel bridge circuits in a power converter used in power systems.

### BRIEF DESCRIPTION OF THE INVENTION

Aspects and advantages of the invention will be set forth in part in the following description, or may be obvious from the description, or may be learned through practice of the invention.

One exemplary aspect of the present disclosure is directed to a power converter system. The system includes a load and an inverter configured to provide an alternating current output to the load. The inverter includes a first bridge circuit and a second bridge circuit coupled in parallel. Each of the first and second bridge circuits includes a plurality of switching elements coupled in series with one another. The first and second bridge circuits each include a bridge output. The bridge output of the first and second bridge circuits are coupled together at the load.

Another exemplary aspect of the present disclosure is directed to a method of converting power for a load in a power system. The method includes providing power at a power converter. The power inverter includes a first bridge circuit and a second bridge circuit coupled in parallel. Each of the first and second bridge circuits includes a plurality of switching elements coupled in series with one another. The method further includes controlling pulse width modulation of the switching elements of the first and second bridge circuits to provide an alternating current power. The method further includes providing the alternating current power from a bridge output of the first bridge circuit to the load via a first conductor and providing the alternating current power from the bridge output of the second bridge circuit to the load via a second conductor. The first and second conductors are coupled together such that a stray inductance of the first conductor and a stray inductance of the second conductor are effectively coupled between the first bridge circuit and the second bridge circuit.

Yet another exemplary aspect of the present disclosure is directed to a doubly-fed induction generator system. The system includes a wind driven doubly-fed induction generator. The wind driven doubly fed induction generator includes a rotor and a stator. The system further includes a power converter coupled to the rotor of the wind driven doubly-fed induction generator. The power converter includes an inverter. The inverter includes a first bridge circuit and a second bridge circuit coupled in parallel. Each of the first and second bridge circuits includes a plurality of switching elements coupled in series with one another. The first and second bridge circuits each include a bridge output. The bridge output of the first bridge circuit is coupled to the wind driven doubly-fed induction generator via a first conductor. The bridge output of the second bridge circuit is coupled to the wind driven doubly-fed induction generator via a second conductor. The first and second conductors are coupled together such that a stray inductance of the first conductor and a stray inductance of the second conductor reduce current imbalance between the first and second bridge circuits.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary power system having a power converter with parallel bridge circuits.

FIG. 2 depicts a power system according to an exemplary embodiment of the present disclosure;

FIG. 3 depicts a power system according to an exemplary embodiment of the present disclosure;

FIG. 4 depicts an exemplary DFIG system according to an exemplary embodiment of the present disclosure;

FIG. 5 depicts an exemplary wind turbine arrangement according to an exemplary embodiment of the present disclosure; and

FIG. 6 depicts an exemplary method according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a connection for parallel bridge circuits in a power converter to reduce current imbalance between the parallel bridge circuits in the power converter. In particular, a power converter can be used to provide a desired power to a load, such as a generator, motor, electrical grid, or other suitable load. The power converter can include a plurality of bridge circuits, such as a plurality of H-bridge circuits, coupled in parallel to increase the output power capability of the power system. Each of the bridge circuits can include a pair of switching elements, such as insulated gate bipolar transistors (IGBTs), coupled in series with one another. The parallel bridge circuits can be controlled, for instance using control commands (e.g. pulse width modulation commands) provided to the switching elements, to provide a desired output of the power converter.

Timing differences can exist between the switching of the switching elements in the parallel bridge circuits. These timing differences can result from, for instance, different delay times provided by optoisolators and other components of driver circuits used to drive the switching elements. In addition, timing differences can result from controlling the parallel bridge circuit according to a switching pattern that provides for switching of the switching elements in a manner out of phase with one another, such as according to an interleaved switching pattern. The timing differences can induce a voltage across at least one inductive element coupled between the plurality of parallel bridge circuits, resulting in a circulating current between the parallel bridge circuits. The circulating current can cause a current imbalance between the parallel bridge circuits. This current imbalance can reduce operating efficiency of the power converter.

According to aspects of the present disclosure, a bridge output of each of the parallel bridge circuits can be coupled together at the load instead of at the power converter. In particular, the parallel bridge circuits can be coupled together at a location that is physically proximate the physical location of the load, such as at a plurality of terminals associated with the load. By doing so, stray inductance associated with conductors used to couple the bridge outputs of the parallel bridge circuits to the load can be effectively coupled between the parallel bridge circuits. This stray inductance can be used to reduce the size of or to eliminate output inductors coupled to the bridge outputs to reduce high frequency components of the output provided by the power converter. In addition, the extra inductance from the conductors can reduce the amount of current circulating between the parallel bridge circuits, leading to reduced current imbalance between the parallel bridge circuits.

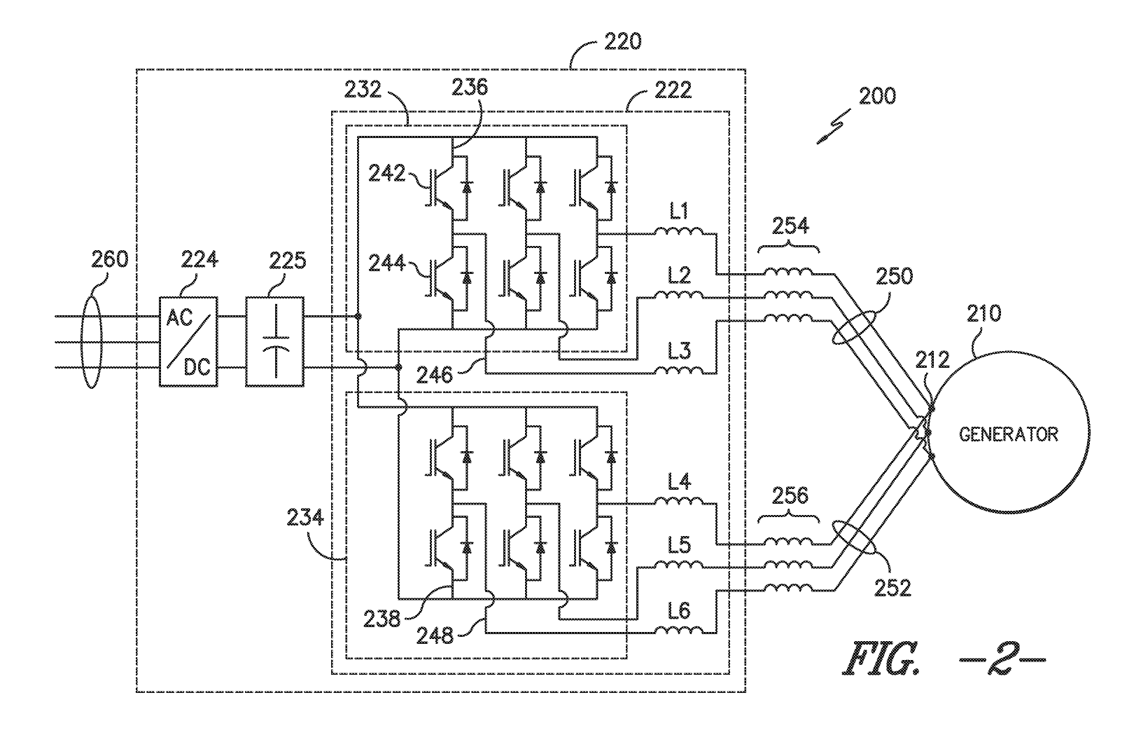

With reference now to the FIGS., exemplary embodiments of the present disclosure will now be discussed in detail. For example, FIG. 2 depicts an exemplary power system 200 according to an exemplary embodiment of the present disclosure. The power system 200 includes a generator 210 configured to generate AC power and provide the AC power to a power converter 220. The present disclosure will be discussed with reference to a power generation system where a generator is a load of the power system 200. Those of ordinary skill in the art, using the disclosures provided herein, will understand that the power system 200 can be used with any type of load, such as a motor, generator, electrical grid, or other suitable load. In addition, while a generator is traditionally a supplier of electrical power, a generator can act as a load for purposes of the present disclosure.

The power converter 220 is a two stage power converter and includes an inverter 222 and a line side converter 224 coupled together by a DC link 225. The inverter 222 receives multiphase (e.g. 3-phase) AC power from the generator 210 and converts the AC power to DC power for application to the DC link 225. The line side converter 224 converts the DC power on the DC link 225 to a suitable AC output power to provide to the electrical grid via a line bus 260.

As illustrated, the inverter 222 can include a first bridge 232 and a second bridge 234. Each bridge 232 and 234 can include a bridge circuit for each phase (e.g. each of three phases) of the power converter 220. For instance, first bridge 232 includes a bridge circuit 236 for a phase of the first bridge 232. Second bridge 234 can include a bridge circuit 238 for a phase of the second bridge 234. The first bridge 232 and the second bridge 234 can be paralleled together such that the bridge circuit 236 is coupled in parallel with the bridge circuit 238. The line side converter 224 can also include a plurality of bridge circuits coupled in parallel. Using parallel bridge circuits can increase the output power capability of the power converter 220.

Each bridge circuit includes a plurality of switching elements (e.g. IGBTs) coupled in series with one another. For instance, each bridge circuit includes an upper IGBT (e.g. IGBT 242) and a lower IGBT (e.g. IGBT 244). It will be appreciated by those of ordinary skill in the art that other suitable switching elements can be used in place of IGBTs, such as MOSFETs or other suitable switching elements. A diode is coupled in parallel with each of the IGBTs. Each bridge circuit can provide a bridge output at a node between the plurality of switching elements coupled in series. For instance, bridge circuit 236 provides bridge output 246. Bridge circuit 238 provides bridge output 248.

The bridge circuits of the power converter 220 are controlled, for instance, by providing control commands, using a suitable driver circuit, to the gates of the IGBTs. For example, a controller can provide suitable gate timing commands to the gates of the IGBTs of the bridge circuits. The control commands can control the pulse width modulation of the IGBTs to provide a desired output. The parallel bridge circuits, such as parallel bridge circuits 236 and 238, can be controlled according to any suitable switching pattern, such as according to an interleaved switching pattern or a non-interleaved switching pattern.

As illustrated, the bridge output of each bridge circuit includes an output inductor L1-L6. The output inductors L1-L6 can be used to filter high frequency components of the output power generated by the power converter 120. The output inductors L1-L6 can be built as three-phase components (e.g. wound on a single magnetic core with a separate magnetic path for each phase) such that L1-L3 are built on a single core and L4-L6 are built on a single core.

As shown in FIG. 2, the bridge outputs of the bridge circuits of the first bridge 232 are coupled to the generator 210 via first conductors 250. For instance, bridge output 246 of bridge circuit 236 is coupled to the generator 210 via one of the first conductors 250. Similarly, the bridge outputs of the bridge circuits of the second bridge 234 are coupled to the generator 210 via second conductors 252. For instance, bridge output 248 of the bridge circuit 238 is coupled to the generator 210 via one of the second conductors 252. Conductors 250 and 252 can include a bus, conductive wiring, or other suitable conductor for delivering power between the power converter 220 and the generator 210.

The conductors 250 and 252 can include stray inductance. For instance, conductors 250 can include stray inductance 254. Conductors 252 can include stray inductance 256. According to aspects of the present disclosure, the parallel bridge circuits of the power converter 220 are coupled together in a manner such that the stray inductances 254 and 256 are effectively coupled between the parallel bridge circuits.

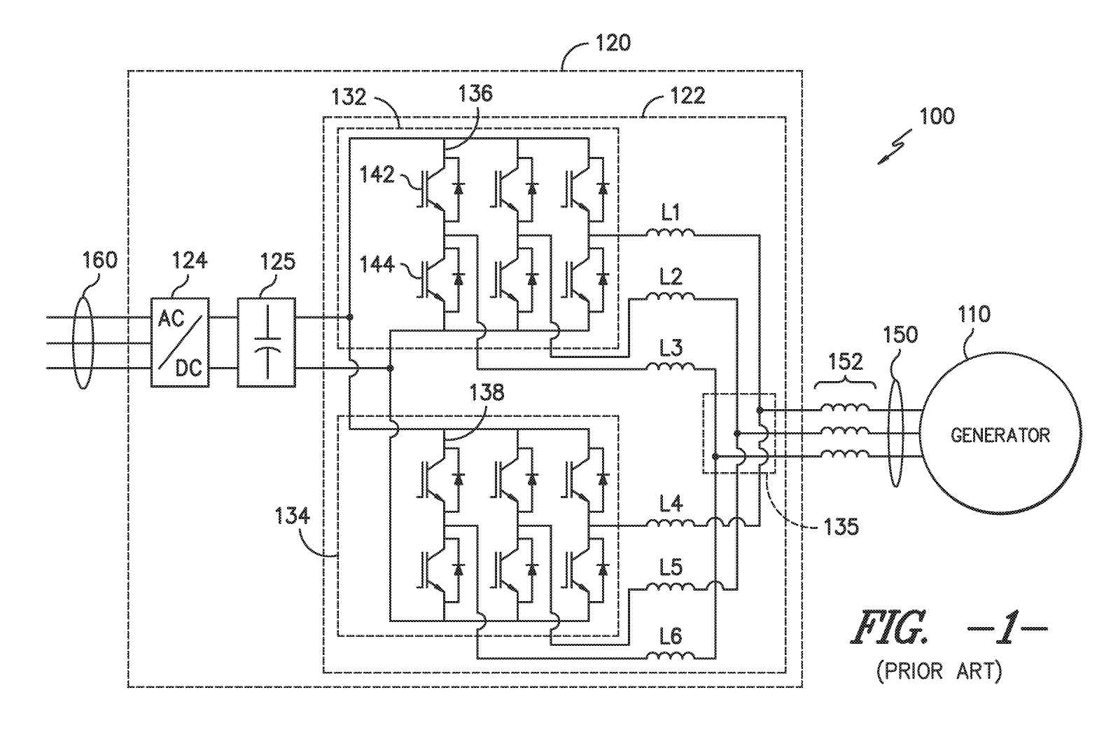

In particular, instead of paralleling the bridge outputs of the parallel bridge circuits at the power converter as shown in FIG. 1, the bridge outputs of the parallel bridge circuits are coupled together at the generator 210. In particular, the bridge outputs of the parallel bridge circuits are coupled together at the generator 210 by coupling the conductors 250 and 254 at the generator 210. For instance, the generator 210 can have a terminal structure 212. The bridge outputs of the parallel bridge circuits can be coupled together at the generator 210 by coupling the conductors 250 and 254 together at the terminal structure 212. In this manner, the bridge outputs of parallel bridge circuits are coupled together at a physical location proximate to the physical location of the generator 210.

Coupling the bridge outputs of the bridge circuits together at the generator 120 effectively couples the stray inductance 254 and 256 of the conductors 250 and 252 between the parallel bridge circuits. For example, the output inductors L1 and L6 in addition the stray inductances 254 and 256 of the conductors 250 and 252 are effectively coupled between the parallel bridge circuits 236 and 238. This additional inductance coupled between the parallel bridge circuits can allow the output inductors L1-L6 to be smaller, leading to reduced costs. In addition, the additional stray inductances 254 and 256 coupled between the parallel bridge circuits can reduce current imbalance between the parallel bridge circuits.

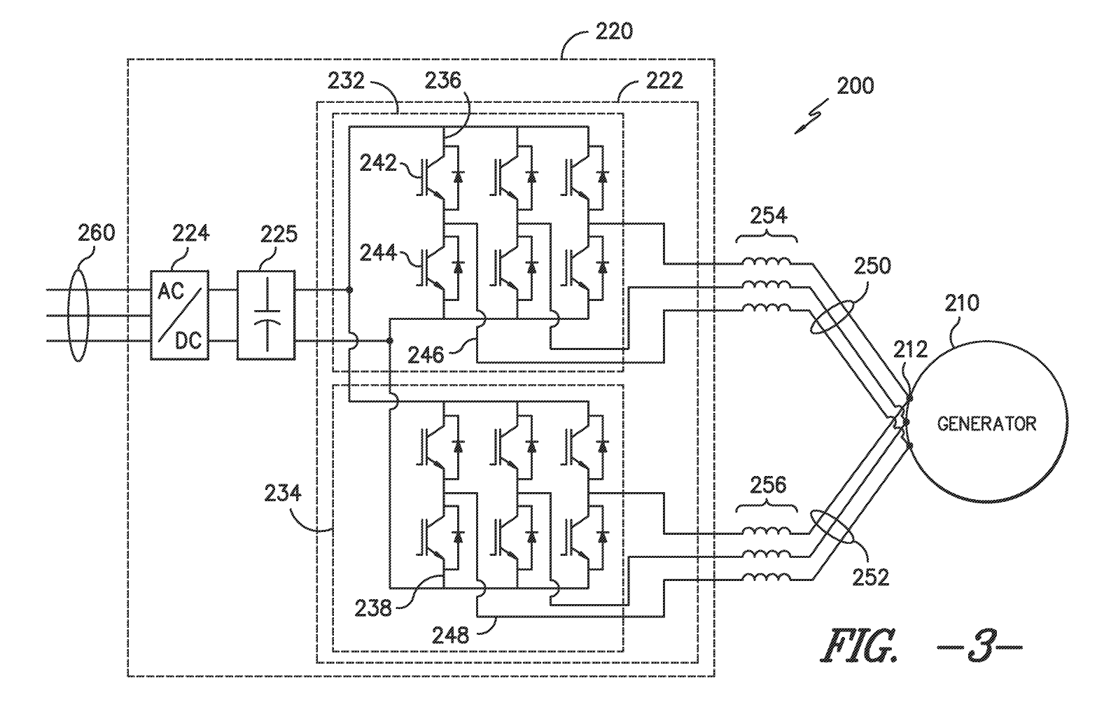

If the additional stray inductances 254 and 256 are large enough, the output inductors L1-L6 may no longer be necessary to filter high frequency components of the output provided by the power converter 220. For instance, as shown in FIG. 3, there are no output inductors coupled to the bridge outputs of the parallel bridge circuits of the power converter 220. In the embodiment shown in FIG. 3, the stray inductances 254 and 256 are effectively coupled between the parallel bridge circuits. For instance, the stray inductances 254 and 256 are effectively coupled between the bridge circuit 236 and the bridge circuit 238. The stray inductances 254 and 256 are effectively coupled between the parallel bridge circuits by coupling the bridge outputs of the parallel bridge circuits together at the generator 210, for instance, by coupling the conductors 250 and 252 together at a terminal structure associated with the generator 210.

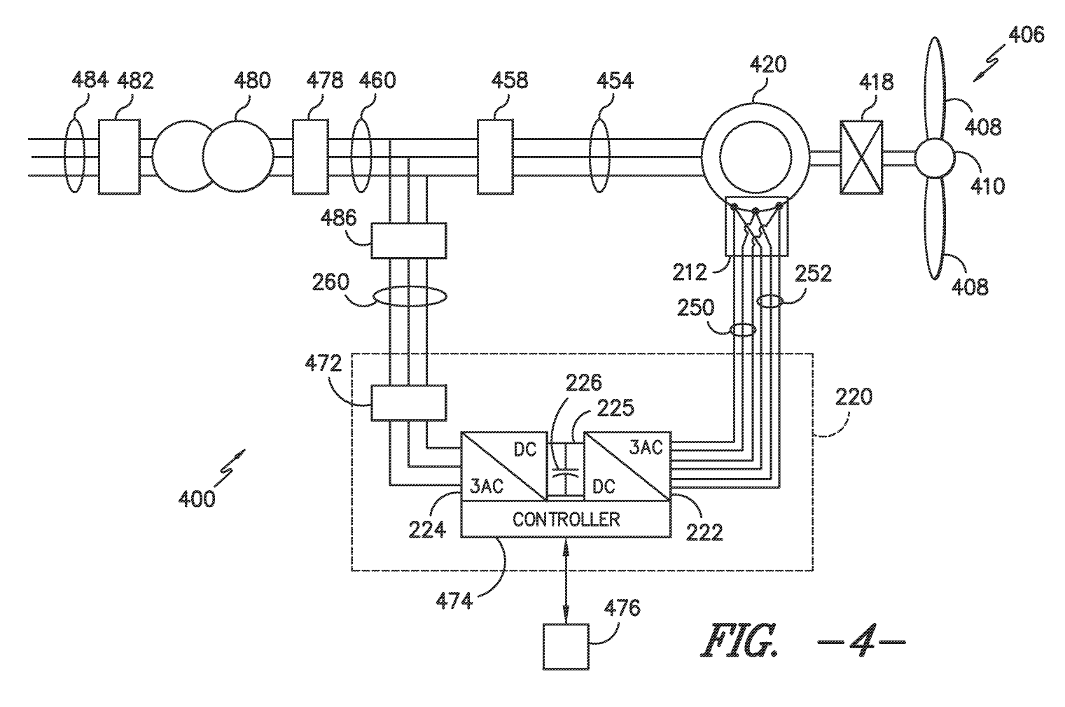

An exemplary application of the present disclosure will now be discussed with reference to an exemplary DFIG wind turbine system. FIG. 4 depicts an exemplary DFIG wind turbine system 400 according to an exemplary embodiment of the present disclosure. In the exemplary system 400, a rotor 406 includes a plurality of rotor blades 408 coupled to a rotating hub 410, and together define a propeller. The propeller is coupled to an optional gear box 418, which is, in turn, coupled to a generator 420. In accordance with aspects of the present disclosure, the generator 420 is a doubly fed induction generator (DFIG) 420.

DFIG 420 can be coupled to a stator bus 454. The stator bus 454 provides an output multiphase power (e.g. three-phase power) from a stator of DFIG 420. The rotor of the DFIG can be coupled to the power converter 220 via conductors 250 and 252. The power converter 220 can have a similar configuration to the power converters 220 depicted in FIGS. 2 and 3. In particular, DFIG 420 is coupled via the conductors 250 and 252 to an inverter 222. The inverter 222 is coupled to a line side converter 224 which in turn is coupled to a line side bus 260.

In exemplary configurations, the inverter 222 and the line side converter 224 are configured for normal operating mode in a three-phase, pulse width modulation (PWM) arrangement using insulated gate bipolar transistor (IGBT) switching elements as discussed in detail above. The inverter 222 and the line side converter 224 can be coupled via a DC link 225 across which is the DC link capacitor 226.

The power converter 220 can be coupled to a controller 474 to control the operation of the inverter 222 and the line side converter 224. It should be noted that the controller 474, in typical embodiments, is configured as an interface between the power converter 220 and a control system 476. The controller 474 can include any number of control devices. In one implementation, the controller 474 can include a processing device (e.g. microprocessor, microcontroller, etc.) executing computer-readable instructions stored in a computer-readable medium. The instructions when executed by the processing device can cause the processing device to perform operations, including providing control commands (e.g. pulse width modulation commands) to the switching elements of the power converter 220.

In typical configurations, various line contactors and circuit breakers including, for example, grid breaker 482 can be included for isolating the various components as necessary for normal operation of DFIG 420 during connection to and disconnection from the electrical grid 484. A system circuit breaker 478 can couple the system bus 460 to a transformer 480, which is coupled to the electrical grid 484 via grid breaker 482.

In operation, alternating current power generated at DFIG 420 by rotating the rotor 406 is provided via a dual path to electrical grid 484. The dual paths are on the stator side by the stator bus 454 and on the rotor side by at least the conductors 250 and 252. On the rotor side, sinusoidal multi-phase (e.g. three-phase) alternating current (AC) power is provided to the power converter 220. The inverter 222 converts the AC power provided from DFIG 420 into direct current (DC) power and provides the DC power to the DC link 225. Switching elements (e.g. IGBTs) used in parallel bridge circuits of the inverter 222 can be modulated to convert the AC power provided from DFIG 420 into DC power suitable for the DC link 225.

The line side converter 224 converts the DC power on the DC link 225 into AC output power suitable for the electrical grid 484. In particular, switching elements (e.g. IGBTs) used in bridge circuits of the line side power converter 224 can be modulated to convert the DC power on the DC link 225 into AC power on the line side bus 260. The AC power from the power converter 220 can be combined with the power from the stator of DFIG 420 to provide multi-phase power (e.g. three-phase power) having a frequency maintained substantially at the frequency of the electrical grid 484 (e.g. 50 Hz/60 Hz).

Various circuit breakers and switches, such as grid breaker 482, system breaker 478, stator sync switch 458, converter breaker 486, and line contactor 472 can be included in the system 400 to connect or disconnect corresponding buses, for example, when current flow is excessive and can damage components of the wind turbine system 400 or for other operational considerations. Additional protection components can also be included in the wind turbine system 400.

The power converter 220 can receive control signals from, for instance, the control system 476 via the controller 474. The control signals can be based, among other things, on sensed conditions or operating characteristics of the wind turbine system 400. Typically, the control signals provide for control of the operation of the power converter 220. For example, feedback in the form of sensed speed of the DFIG 420 can be used to control the conversion of the output power from the rotor of the DFIG 420 to maintain a proper and balanced multi-phase (e.g. three-phase) power supply. Other feedback from other sensors can also be used by the controller 474 to control the power converter 220, including, for example, stator and rotor bus voltages and current feedbacks. Using the various forms of feedback information, switching control signals (e.g. gate timing commands for IGBTs), stator synchronizing control signals, and circuit breaker signals can be generated.

As discussed above, the inverter 222 of the power converter 220 can include parallel bridge circuits to increase output power capability of the power converter 220. The bridge outputs of these parallel bridge circuits can be coupled together at the DFIG 420. In particular, the bridge outputs of the parallel bridge circuits can be coupled together, via conductors 250 and 252, at a terminal structure 212 associated with the DFIG 420. Coupling the parallel bridge circuits together in this manner can reduce current imbalance among the parallel bridge circuits.

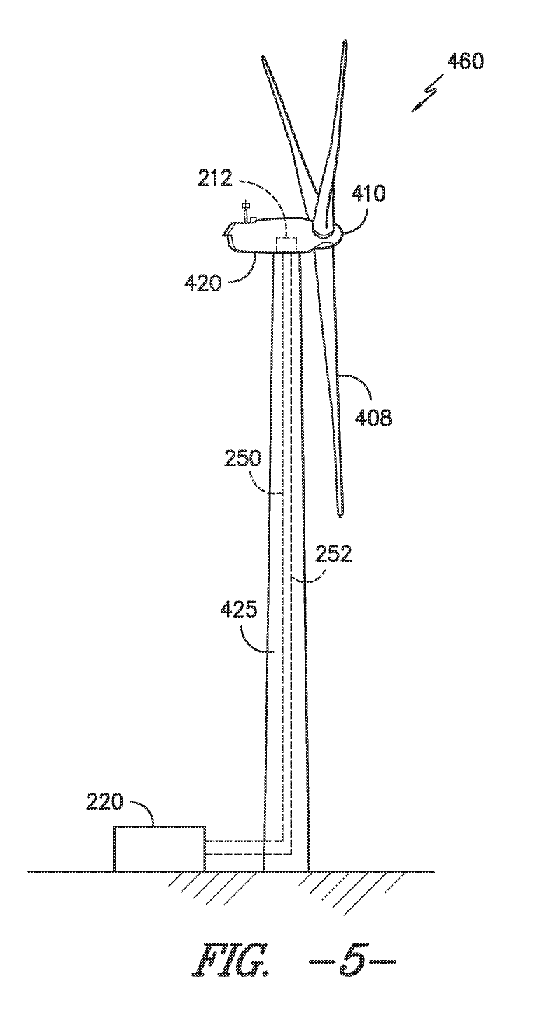

This can be further appreciated with reference to FIG. 5. FIG. 5 depicts an exemplary wind turbine structure 460 in which a DFIG 420 is supported by a wind tower 425. The rotor of the DFIG 420 can be coupled to the power converter 220 via conductors 250 and 252. As illustrated, conductors 250 and 252 are tower conductors that travel the length of the tower 425 supporting the DFIG 420. The conductors 250 and 252 are coupled together at a terminal structure 212 that is physically proximate the location of the DFIG 420. In this manner, the stray inductance associated with conductors 250 and 252 are effectively coupled between the parallel bridge circuits of the power converter 220 as discussed above.

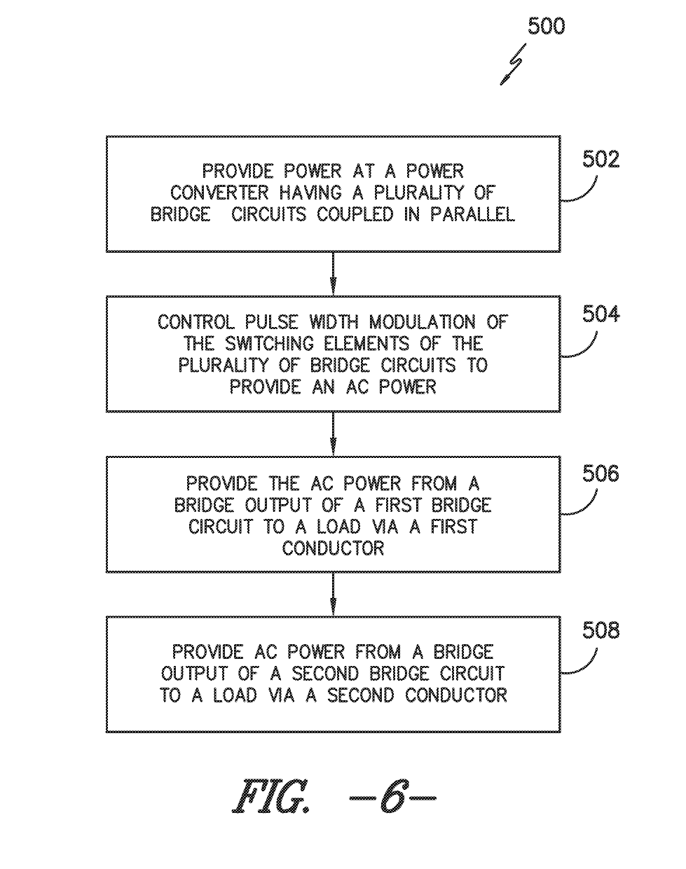

FIG. 6 depicts a flow diagram of an exemplary method (500) according to an exemplary embodiment of the present disclosure. The method (500) can be implemented using any suitable system, such as any of the systems illustrated in FIGS. 2-5. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (502), the method includes providing power at a power converter having a plurality of bridge circuits coupled in parallel. For instance, AC power can be provided at the power converter 220 of FIG. 2. Those of ordinary skill in the art, using the disclosures provided herein, will understand that providing power at the power converter can encompass both providing power from the power converter and providing power to the power converter depending on the direction of power flow in the system. For instance, in the exemplary power generation system 200 of FIG. 2, power can be provided from the power converter 220 to a bus 220 after the power generated at the generator 210 has been converted into suitable output power by the power converter 220. In an exemplary application where the power converter is used to provide power to a load such as a motor, the power can be provided to the power converter from a suitable source to be converted into a suitable power for driving the motor.

The power converter can include a plurality of bridge circuits coupled in parallel. For instance, referring to the exemplary power converter 220 of FIG. 2, the power converter 220 includes a bridge circuit 236 coupled in parallel with a bridge circuit 238. Each of the plurality of bridge circuits can include a plurality of switching elements coupled in series with another. For instance, bridge circuit 236 includes an upper IGBT (e.g. IGBT 242) and a lower IGBT (e.g. IGBT 244).

At (504) of FIG. 6, the method includes controlling pulse width modulation of the switching elements of the plurality of bridge circuits coupled in parallel to provide an alternating current power. The switching elements of the parallel bridge circuits can be controlled according to any suitable control scheme, such as pursuant to an interleaved control scheme or a non-interleaved control scheme. The alternating current power can then be delivered to a load, such as a motor, generator, electrical grid, or other suitable load.

In particular at (506), the method can include providing the alternating current power from a bridge output of a first bridge circuit to the load via a first conductor. For instance, as shown in FIG. 2, alternating current power can be provided from the bridge output 246 of the bridge circuit 236 via one of the first conductors 250. Referring back to FIG. 6 at (508), the method can include providing the alternating current power from a bridge output of a second bridge circuit to the load via a second conductor. For instance, as shown in FIG. 2, alternating current power can be provided from the bridge output 248 of the bridge circuit 238 via one of the second conductors 252.

According to exemplary aspects of the present disclosure, the bridge outputs of the parallel bridge circuits are coupled together at the load. For instance, the first and second conductors coupling the bridge output of the first bridge circuit and the bridge output of the second bridge circuit to the load can be coupled together at a physical location proximate the location of the load. In this manner, stray inductance of the conductors coupling the power converter to the load can be effectively coupled between the parallel bridge circuits of the power converter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A power converter system for use in a power system, the power converter system comprising:
a load; and
an inverter configured to provide an alternating current output to the load, the inverter comprising a first bridge circuit and a second bridge circuit coupled in parallel, each of the first and second bridge circuits comprising a plurality of switching elements coupled in series with one another;
wherein the first and second bridge circuits each comprise a bridge output, the bridge output of the first and second bridge circuits being coupled together at the load such that the bridge output of the first bridge circuit is coupled to the load via a first conductor and the bridge output of the second bridge circuit is coupled to the load via a second conductor, the first conductor and the second conductor both individually coupled to a terminal structure of the load.

2-4. (canceled)

5. The power converter system of claim 1, wherein the first conductor and the second conductor each have a stray inductance, the first conductor and the second conductor being coupled together at the load such that the stray inductance of the first conductor and the second conductor is effectively coupled between the first bridge circuit and the second bridge circuit.

6. The power converter system of claim 5, wherein the system further comprises a first output inductor coupled in series with the bridge output of the first bridge circuit and a second output inductor coupled in series with the bridge output of the second bridge circuit.

7. The power converter system of claim 6, wherein the first output inductor and the second output inductor are effectively coupled between the first bridge circuit and the second bridge circuit.

8. The power converter system of claim 1, wherein the load is a motor.

9. The power converter system of claim 1, wherein the load is a generator.

10. The power converter system of claim 1, wherein the load is a wind driven generator, the first and second conductors comprising tower conductors traveling the length of a tower supporting the wind driven generator.

11. The power converter system of claim 1, wherein the inverter is coupled to a line side converter via a DC link.

12. The power converter system of claim 10, wherein the inverter is configured to convert DC power on the DC link to AC power for the load.

13. The power converter system of claim 11, wherein the line side converter is coupled to an electrical grid.

14. A method of converting power for a load in a power system, the method comprising:
providing power at a power converter, the power converter comprising a first bridge circuit and a second bridge circuit coupled in parallel, each of the first and second bridge circuits comprising a plurality of switching elements coupled in series with one another;
controlling pulse width modulation of the switching elements of the first and second bridge circuits to provide an alternating current power; and
providing the alternating current power from a bridge output of the first bridge circuit to the load via a first conductor; and
providing the alternating current power from the bridge output of the second bridge circuit to the load via a second conductor;
wherein the first and second conductors are both individually coupled to a terminal structure of the load such that the bridge output of the first bridge circuit and the bridge output of the second bridge circuit are coupled together at the load and such that a stray inductance of the first conductor and a stray inductance of the second conductor are effectively coupled between the first bridge circuit and the second bridge circuit.

15. (canceled)

16. The method of claim 14, wherein the load is a wind driven generator, the first and second conductors comprising tower conductors traveling the length of a tower supporting the wind driven generator.

17. A doubly-fed induction generator system, comprising:
a wind driven doubly-fed induction generator, the wind driven doubly-fed induction generator comprising a rotor and a stator;
a power converter coupled to the rotor of the wind driven doubly-fed induction generator, the power converter comprising an inverter, the inverter comprising a first bridge circuit and a second bridge circuit coupled in parallel, each of the first and second bridge circuits comprising a plurality of switching elements coupled in series with one another;
wherein the first and second bridge circuits each comprise a bridge output, the bridge output of the first bridge circuit being coupled to the wind driven doubly-fed induction generator via a first conductor and the bridge output of the second bridge circuit being coupled to the wind driven doubly-fed induction generator via a second conductor, the first conductor and the second conductor being both individually coupled to a terminal structure of the load such that the bridge output of the first bridge circuit and the bridge output of the second bridge circuit are coupled together at the load and such that a stray inductance of the first conductor and a stray inductance of the second conductor reduce current imbalance between the first and second bridge circuits.

18. (canceled)

19. The doubly-fed induction generator system of claim 17, wherein the first conductor and the second conductor comprise one or more tower conductors traveling the length of a tower supporting the wind driven doubly-fed induction generator.

20. The doubly-fed induction generator system of claim 17, wherein the system comprises a first output inductor coupled in series with the bridge output of the first bridge circuit and a second output inductor coupled in series with the bridge output of the second bridge circuit.
